(19) United States
(12) Patent Application Publication
(10) Pub. No.: US 2008/0156884 A1
(43) Pub. Date: Jul. 3, 2008

(54) Memory card having double contact pads and method for manufacturing the same

(75) Inventors: Hyun-Ho Choi, Hwaseong-si (KR); Jong-Woon Kim, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/784,092

(22) Filed: Apr. 5, 2007

(30) Foreign Application Priority Data
Jan. 2, 2007 (KR) 10-2007-0000231

(51) Int. Cl. G06K 21/06

(52) U.S. Cl. 235/492; 29/825

(57) ABSTRACT

A memory card is configured for insertion into a data reproducing apparatus. The memory card comprises a plurality of first contact pads on a first surface of the memory card configured to contact a plurality of contact terminals of the data reproducing apparatus; and a plurality of second contact pads on a second surface of the memory card configured to contact the plurality of contact terminals of the data reproducing apparatus, each one of the plurality of second contact pads being electrically connected to a corresponding one of the plurality of first contact pads. The memory card is configured for insertion into the data reproducing apparatus and for operation therewith, regardless of which of the first and second surfaces and corresponding contact pads are positioned to face the plurality of contact terminals of the data reproducing apparatus when the memory card is inserted into a data reproducing apparatus.

### CROSS-REFERENCE TO RELATED APPLICATIONS

This U.S. non-provisional patent application claims priority under 35 U.S.C. § 119 to Korean Patent Application No. 10-2007-0000231, filed on Jan. 2, 2007, the entire content of which is hereby incorporated by reference.

### BACKGROUND OF THE INVENTION

Embodiments of the present invention disclosed herein relate to a memory card and a method for manufacturing the same, and more particularly, to a memory card having double contact pads disposed on both an upper surface and a lower surface thereof and a method for manufacturing the same.

A memory card operates stores data transmitted from a host and retrieves data for the host. There are many different kinds of memory cards, including subscriber identification module (SIM) cards, flash cards, and the like. The memory cards include various storage units that store data. For example, flash cards, such as a multi-media card (MMC), an extreme digital (xD) card, a secure digital (SD) card, and the like, includes non-volatile flash memory, which serves as a data storage unit for the flash memory card.

The memory card is inserted into a host or a data reproducing apparatus. The memory card includes contact pads through which data is transmitted between the memory card and the host or the data reproducing apparatus. The contact pads of the memory card contacts contact terminals of the host or data reproducing apparatus.

In conventional memory cards, contact pads are formed on only one surface thereof, and not on both surfaces thereof. Accordingly, the memory card does not operate properly when the card is inserted in an inverted, or upside-down, fashion, such that the wrong surface is put into contact with contact terminals of a data reproducing apparatus. This causes an inconvenience for a user of the memory card.

### SUMMARY OF THE INVENTION

Embodiments of the present invention provides a memory card that operates regardless of which of its upper and lower surfaces is placed in contact with contact terminals of a host or data reproducing apparatus, and a method for manufacturing the same.

A memory card is configured for insertion into a data reproducing apparatus. The memory card comprises a plurality of first contact pads on a first surface of the memory card configured to contact a plurality of contact terminals of the data reproducing apparatus; and a plurality of second contact pads on a second surface of the memory card configured to contact the plurality of contact terminals of the data reproducing apparatus, each one of the plurality of second contact pads being electrically connected to a corresponding one of the plurality of first contact pads. The memory card is configured for insertion into the data reproducing apparatus and for operation therewith, regardless of which of the first and second surfaces and corresponding contact pads are positioned to face the plurality of contact terminals of the data reproducing apparatus when the memory card is inserted into a data reproducing apparatus.

The first or second contact pads can be configured to contact the contact terminals of the data reproducing apparatus to perform the same function regardless of which of the first and second surfaces and corresponding contact pads are positioned to face the plurality of contact terminals of the data reproducing apparatus when the memory card is inserted into a data reproducing apparatus.

The first contact pads and the second contact pads can be arranged in mutually opposite order between a first portion of the memory card and a second portion of the memory card.

The memory card can further comprise first connecting lines connected to the first contact pads, and second connecting lines connected to the second contact pads.

The first connecting lines can be electrically connected to corresponding second connecting lines through contact pins.

The first and second connecting lines can include metal lines.

In another aspect, a method for manufacturing a memory card comprises: attaching memory chips on a printed circuit board; wire-bonding the memory chips to a plurality of lower surface contact pads of the memory card; providing a plurality of upper surface contact pads at a lid of the memory card; and electrically connecting each one of the plurality of the lower surface contact pads to a corresponding one of the upper surface contact pads, wherein the upper surface contact pads and the lower surface contact pads are arranged in mutually opposite order between a first portion of the memory card and a second portion of the memory card.

The method can further comprise injecting an epoxy mold compound to shield structures formed by the wire-bonding.

The method can further comprise testing the memory card following electrically connecting each one of the plurality of the lower surface contact pads to a corresponding one of the upper surface contact pads.

The testing of the memory card can comprise ensuring proper electrical operation of the memory card.

The testing of the memory card can also comprise visually inspecting a marking of the memory card.

### BRIEF DESCRIPTION OF THE FIGURES

The accompanying figures are included to provide a further understanding of the present invention, and are incorporated in, and constitute a part of, this specification. The drawings illustrate exemplary embodiments of the present invention and, together with the description, serve to explain principles of the present invention. In the figures:

FIG. 1 is a schematic view illustrating a data reproducing apparatus and a memory card according to embodiments of the present invention;

FIG. 2 is a block diagram illustrating an internal wiring of a memory card according to embodiments of the present invention;

FIG. 3 is a cross-sectional view of a package of the memory card shown in FIG. 1;

FIG. 4 is a flowchart illustrating a method for manufacturing a package of the memory card shown in FIG. 1; and

FIG. 5 is a flowchart that illustrates the encapsulating operation of FIG. 4.

### DETAILED DESCRIPTION OF EMBODIMENTS

Embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete.

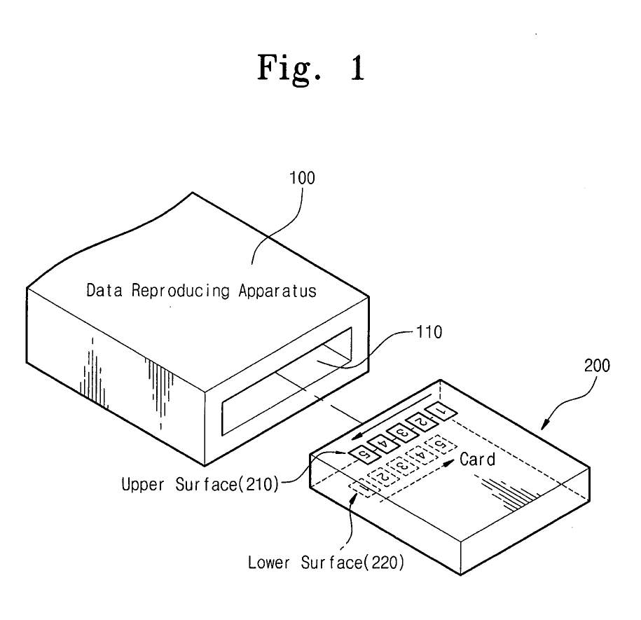

FIG. 1 is a schematic view illustrating a memory card according to an embodiment of the present invention. In the illustration of FIG. 1, the memory card 200 is being inserted into a data reproducing apparatus 100, host, or other device that is compatible with the memory card (collectively referred to hereinafter as a “data reproducing apparatus”).

The data reproducing apparatus 100 includes any apparatus capable of writing data to or reading data from the memory card 200. For example, the data reproducing apparatus 100 can include a computer, a digital camera, a mobile phone, a notebook, a personal digital assistant (PDA), a navigator, and the like that utilize a memory card 200 inserted therein.

The data reproducing apparatus 100 includes a memory card slot 110 into which the memory card 200 is inserted. The memory card slot 110 includes contact terminals (not shown) that is configured to make electrical contact with contact pads of the memory card 200. Data are transmitted between the data reproducing apparatus 100 and the memory card 200 through the contact terminals.

The memory card 200 stores data received from and provided to the data reproducing apparatus 100. To this end, the memory card 200 includes a data storage unit (not shown). For example, the data storage unit may be in the form of a non-volatile flash memory device, a volatile memory device, or the like. The memory card 200 also includes a controller (not shown) for controlling the data storage unit in response to commands provided by the data reproducing apparatus 100.

Referring to FIG. 1, the memory card 200 includes a plurality of contact pads (labeled 1-5) for contacting the contact terminals of the data reproducing apparatus 100. Different kinds of memory cards can have a different number of contact pads. FIG. 1 illustrates a memory card having five contact pads 1, 2, 3, 4, and 5, for example. The memory card 200 configured in accordance with embodiments of the present invention has contact pads both on an upper surface 210 and on a lower surface 220 thereof.

In other words, the memory card 200 according to the present invention has two sets of contact pads, a first set being disposed on an upper surface and a second set being disposed on a lower surface. The memory card 200 can be inserted into a data reproducing apparatus and is operable regardless of which of its upper and lower surfaces 210 and 220 is placed into contact with contact terminals of the data reproducing apparatus 100. The memory card 200 configured in accordance with embodiments of the present invention obviates the problems associated with of conventional memory cards, which are inoperable if inserted into a data reproducing apparatus in an inverted fashion such that the wrong surface makes contact with contact terminals of the data reproducing apparatus. In addition, the memory card 200 according to the present invention can also obviate the inconvenience of having to insert the memory card so that the correct surface makes contact with the contact terminals of the data reproducing apparatus.

Referring again to FIG. 1, the contact pads in the upper surface 210 are arranged in opposite order relative to the contact pads in the lower surface 220, which may be seen from the arrows in FIG. 1. Accordingly, contact pads in a surface of the memory card 200 facing the contact terminals of the data reproducing apparatus are arranged in the same order, even in the event that the memory card is inserted upside down into the data reproducing apparatus. That is, the memory card 200 according to the present invention presents the same arrangement of contact pads 1-5 to the contact terminals of the data reproducing apparatus 100, and performs the same function, irrespective of which of the upper and lower surfaces 210 and 220 face upward when the memory card is inserted into the data reproducing apparatus.

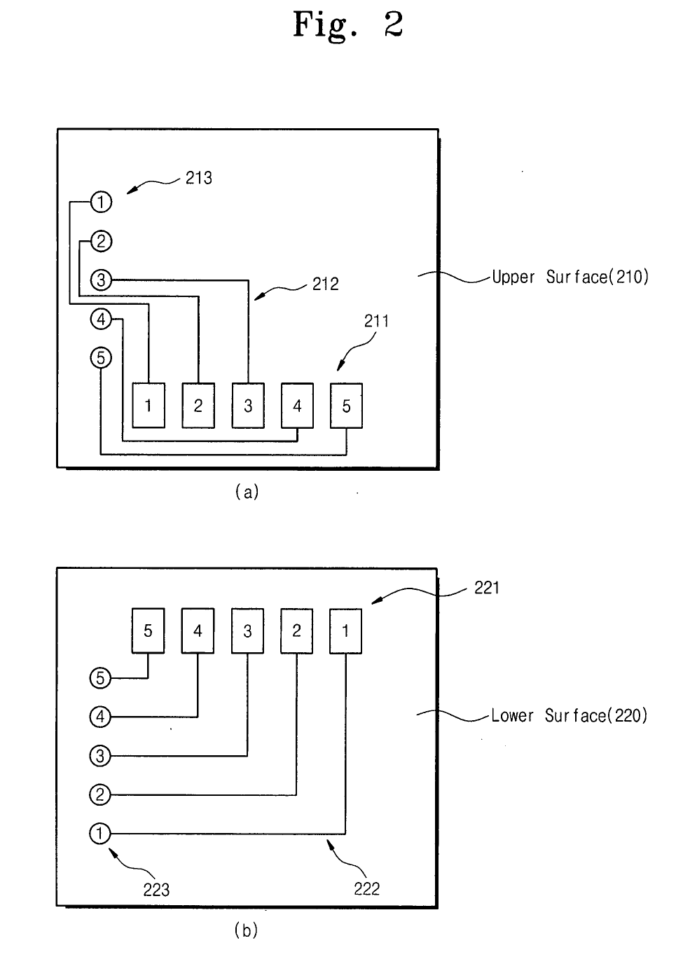

FIG. 2 is a block diagram illustrating an internal wiring arrangement of a memory card configured in accordance with embodiments of the present invention. FIG. 2A illustrates an internal wiring arrangement at an upper surface 210 of the memory card, and FIG. 2B illustrates an internal wiring arrangement at a lower surface 220 of the memory card.

Referring to FIG. 2A, the upper surface 210 of the memory card includes first contact pads 211, first connecting lines 212, and first contact pins 213. When the memory card is inserted into the data reproducing apparatus 100 with the upper surface 210 facing the contact terminals of the data reproducing apparatus 100 (see FIG. 1), the first contact pads 211 are in position to make proper contact with the contact terminals. The first contact pads 211 are connected to the first connecting lines 212. The first connecting line 212 may be a metal line, a metal wiring, or the like, that can be provided on multiple wiring layers of the memory card. The first contact pin 213 connects to an end of the first connecting line 212 associated with each of the first contact pads.

Referring to FIG. 2B, the lower surface 220 of the memory card includes second contact pads 221, second connecting lines 222, and second contact pins 223. When the memory card is inserted into the data reproducing apparatus 100 with the lower surface 220 facing the contact terminals of the data reproducing apparatus 100 (see FIG. 1), the second contact pads 221 are in position to make proper contact with the contact terminals. The second contact pads 221 are connected to the second connecting lines 222. The second connecting line 222 may be a metal line, a metal wiring, or the like, that can be provided on multiple wiring layers of the memory card. The second contact pin 223 connects to an end of the second connecting line 222 associated with each of the first contact pads.

The first contact pin 213 and the second contact pin 223 serve together as a connection point providing a one-to-one electrical connection between the first contact pad 211 and the second contact pad 221 when the upper surface 210 and the lower surface 220 of the memory card 200 are joined together, or otherwise fabricated. The first and second connecting lines 212 and 222 are designed such that the memory card 200 performs the same functions regardless of which surface of the memory card 200 is placed in position during mounting or insertion to face the contact terminals. It should be understood that the wiring structure of the first and second connecting lines 212 and 222 depicted in FIG. 2 is merely illustrative and that it should not be taken in a limiting sense. One skilled in the art would make various modifications and variations, depending on the application.

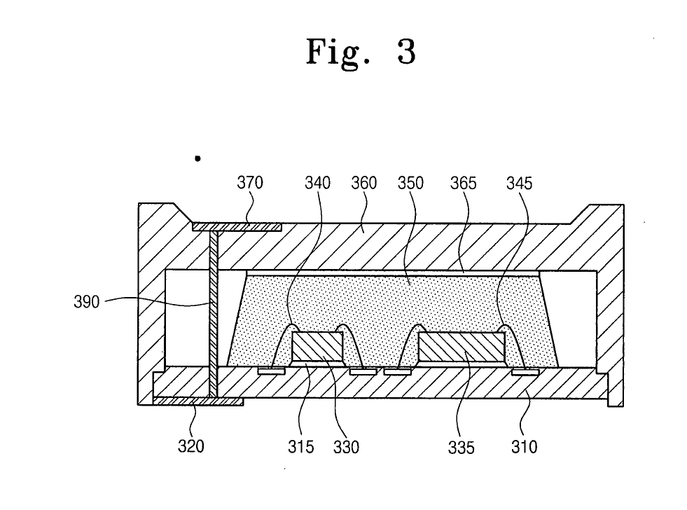

FIG. 3 is a cross-sectional view of a package of the memory card shown in FIG. 1. Referring to FIG. 1, the package includes a lower surface and an upper surface. The lower surface has a printed circuit board (PCB) 310, integrated circuit or chips 330 and 335, and bonding wires 340 and 345. The upper surface has an epoxy mold compound (EMC) 350 and a lid 360.

The package also includes lower surface pads 320 disposed on the PCB 310 and upper surface pads 370 disposed on the lid 360. Chip attachment parts 315 attach the chips 330 and 335 to the PCB 310. A lid attachment part 365 attaches the EMC 350 to the lid 360.

The bonding wires 340, 345, formed of a conductive material, connect pad portions of the chips 330, 335 to conductive portions of the PCB 310, and transmit electrical signals between the chips 330, 335 and conductive portions of the PCB 310. The EMC 350 is an insulating material for covering the bonding wires and the chips to shield the bonding wires from physical or chemical exposure. The EMC 350 is initially liquid when applied, and later solidifies to prevent movement of the chips 330 and the lid 360.

Windows of a conductive material are formed at the upper surface pads 370 in the lid 360 of the package. Insulation materials cover the other portion of the lid 360. The upper surface pads are connected to the lower surface pads through electrical connection parts 390. Since the upper surface pads and the lower surface pads are arranged in mutually opposite order, the electrical connection parts 390 can have a wiring structure such as that shown in FIG. 2.

With increased integration of electronic devices, precision manufacturing processes are required due to the limitations in the thicknesses of the semiconductor package, while an increasing number of pads are required on the outer surface of the package for increased connectivity with external systems.

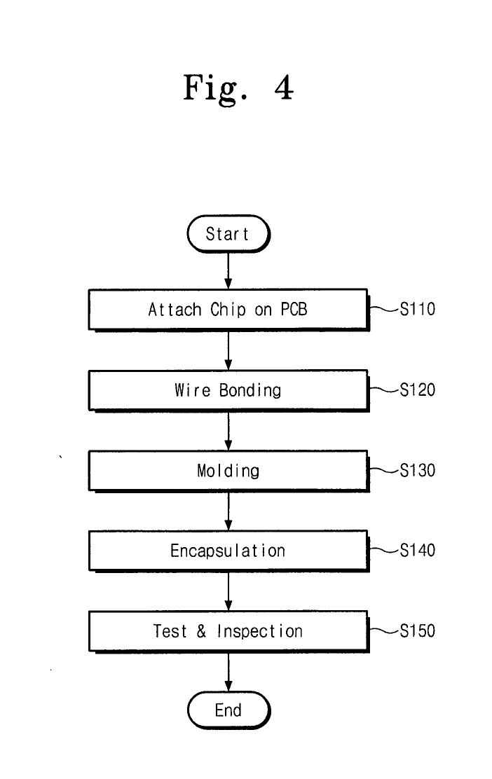

FIG. 4 is a flowchart illustrating a method for manufacturing a package of the memory card shown in FIG. 1. Referring to FIG. 4, a method for manufacturing a memory card according to the present invention includes attaching chips on a PCB (S110), wire bonding (S120), molding (S130), encapsulating (S140), and testing (S150).

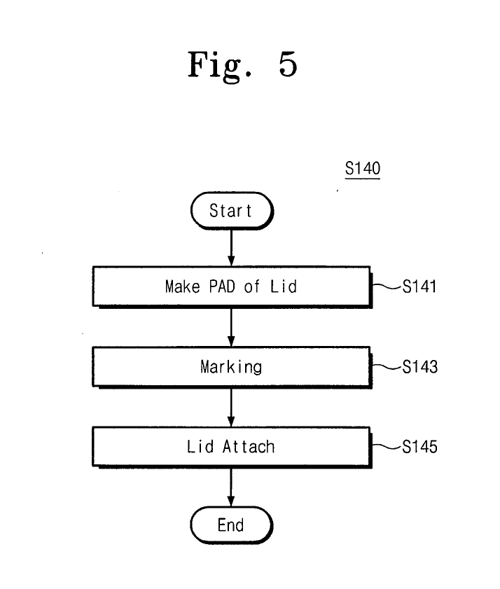

In the attaching of the chips on the PCB (S110), a memory device, a controller and other devices are attached on a PCB. In the wire bonding (S120), pads of the chip and leads of a package are interconnected by conductive wires. In the molding (S130), an EMC is injected in order to shield the chip and the bonding wires from physical or chemical contacts. After the molding (S130), a lower plate including the PCB and insulation materials is completed. In the encapsulating (S140), a lid is manufactured to have windows formed in opposite order relative to the lower surface pads, and then fixed to the lower plate manufactured in the molding (S130), to complete a package of the memory card. The encapsulating (S140) will be described in detail below with reference to FIG. 5. In the testing (S150), an electrical inspection and a visual inspection are performed. The electrical inspection is a process for inspecting whether the packaged chip operates well. The visual inspection is a process for inspecting the marking of the product.

FIG. 5 is a flowchart illustrating the encapsulating of FIG. 4. Referring to FIG. 5, the encapsulating includes providing the pads on a lid (S141), marking the device (S143), and attaching the lid (S145).

The making of the pads in the lid (S141) includes forming pad windows of a conductive material in a portion of an insulating material on an outer portion of the package, and further forming conducting lines for connecting the pads on the lid 370 and the lower surface pads 320 that are arranged in mutually opposite order. In the marking (S143), a code, a number, or the like, including indicia about the product, is marked on a surface of the package. In the attaching of the lid (S145), the upper and lower surfaces are joined together, the EMC and the lid are attached to each other, and conductive contacting portions of the lower surface pads and conductive contacting portions of the upper surface pads are interconnected.

In a conventional memory card, contact pads are formed on only one surface of the card. Accordingly, there occurs a problem that if the memory card is inserted in a wrongs direction, for example, inverted, it will not work in a data reproducing apparatus, such as a digital camera, with the wrong surface facing the contact terminals of the data reproducing apparatus. On the contrary, a memory card according to embodiments of the present invention has contact pads on both an upper surface and a lower surface thereof. In addition, the contact pads on the upper surface and the lower surface are arranged in mutually opposite order, and interconnected by an internal wiring. Accordingly, the memory card can operate regardless of which surface of the memory card faces the contact terminals of the data reproducing apparatus. The simple internal wiring and the double contact pads of the memory card according to the present invention can obviate the inconvenience of having to insert the memory card with the correct surface facing the contact terminals of the data reproducing apparatus.

While the invention have been particularly shown and described with reference to preferred embodiments thereof, it will be understood by those skilled in the art that various changes in form and detail may be made herein without departing from the spirit and scope of the invention as defined by the appended claims.

What is claimed is:

1. A memory card that is configured for insertion into a data reproducing apparatus, the memory card comprising:
a plurality of first contact pads on a first surface of the memory card configured to contact a plurality of contact terminals of the data reproducing apparatus; and
a plurality of second contact pads on a second surface of the memory card configured to contact the plurality of contact terminals of the data reproducing apparatus, each one of the plurality of second contact pads being electrically connected to a corresponding one of the plurality of first contact pads,
wherein the memory card is configured for insertion into the data reproducing apparatus and for operation therewith, regardless of which of the first and second surfaces and corresponding contact pads are positioned to face the plurality of contact terminals of the data reproducing apparatus when the memory card is inserted into a data reproducing apparatus.

2. The memory card of claim 1, wherein the first or second contact pads contact the contact terminals of the data reproducing apparatus to perform the same function regardless of which of the first and second surfaces and corresponding contact pads are positioned to face the plurality of contact terminals of the data reproducing apparatus when the memory card is inserted into a data reproducing apparatus.

3. The memory card of claim 1, wherein the first contact pads and the second contact pads are arranged in mutually opposite order between a first portion of the memory card and a second portion of the memory card.

4. The memory card of claim 1, further comprising first connecting lines connected to the first contact pads, and second connecting lines connected to the second contact pads.

5. The memory card of claim 4, wherein the first connecting lines are electrically connected to corresponding second connecting lines through contact pins.

6. The memory card of claim 4, wherein the first and second connecting lines include metal lines.

7. A method for manufacturing a memory card, the method comprising:
attaching memory chips on a printed circuit board;
wire-bonding the memory chips to a plurality of lower surface contact pads of the memory card;
providing a plurality of upper surface contact pads at a lid of the memory card; and
electrically connecting each one of the plurality of the lower surface contact pads to a corresponding one of the upper surface contact pads,
wherein the upper surface contact pads and the lower surface contact pads are arranged in mutually opposite order between a first portion of the memory card and a second portion of the memory card.

8. The method of claim 7, further comprising injecting an epoxy mold compound to shield structures formed by the wire-bonding.

9. The method of claim 7, further comprising testing the memory card following electrically connecting each one of the plurality of the lower surface contact pads to a corresponding one of the upper surface contact pads.

10. The method of claim 9, wherein the testing of the memory card comprises ensuring proper electrical operation of the memory card.

11. The method of claim 9, wherein the testing of the memory card comprises visually inspecting a marking of the memory card.
